(19) United States
(12) Patent Application Publication
(10) Pub. No.: US 2011/0176878 A1
(43) Pub. Date: Jul. 21, 2011

(54) Drill Head Manufacturing Method and Drill Head

(75) Inventor: Takuji Nomura, Hyogo (JP)

(73) Assignee: Unitac, Inc., Amagasaki-shi (JP)

(21) Appl. No.: 13/007,989

(22) Filed: Jan. 17, 2011

Related U.S. Application Data
(63) Continuation-in-part of application No. PCT/JP2008/072630, filed on Dec. 12, 2008.

(30) Foreign Application Priority Data
Jul. 16, 2008 (JP) 2008-184844

(51) Int. Cl. B23B 51/00; B23K 31/02

(52) U.S. Cl. 408/83; 228/159; 408/144

(57) ABSTRACT

A drill head manufacturing method calls for a cutting tip to be CVD coated, brazed to a distal end of a drill head, polished and then PVD coated. The process effectively utilizes features of a CVD coating, which renders a tool service life longer and enables a drill head more suitable for high-speed cutting to be manufactured. A cutting tip having been CVD coated with a hard material is brazed at a brazing temperature to a predetermined portion at a distal end side of a head main body. An outer diameter portion OD of the brazed tip about a rotation axis of the head main body is polished. Then, the cutting tip and the head main body are PVD coated with a hard material at a second temperature lower than the brazing temperature.

### RELATED APPLICATIONS

This is a Continuation-in-Part of International Application No. PCT/JP2008/072630, filed 12 Dec. 2008 and published as WO 2010/007700 on 21 Jan. 2010, which claims priority to JP 2008-184844, filed 16 Jul. 2008. The contents of the aforementioned International and priority applications are incorporated by reference in their entirety.

### FIELD OF THE INVENTION

The present invention relates to a manufacturing method of a drill head used for drilling a metal workpiece. The present invention further relates to a drill head manufactured by the method.

### BACKGROUND

In manufacturing a drill head, conventionally, first, a cutting tip and a guide pad are silver brazed at a brazing temperature to predetermined portions at a distal end side of a head main body such that an outer diameter portion of the cutting tip is positioned along an outer circumference of the drill head. Then, outer diameter portions of the brazed cutting tip and guide pad about a rotation axis of the head main body are polished to remove partial protrusions of the outer diameter portions and adjust an outer diameter of the drill head. Lastly, a coating over the entire the cutting tip, the guide pad and the head main body is applied.

The aforementioned coating forms a film with a thickness of 3 to 16 μm in a single layer or multiple layers on surfaces of the tip, the guide pad and the head main body by using a hard material such as titanium carbide and titanium nitride. The purpose thereof is to extend a tool service life, in particular, a tip service life. There are two types of this coating, a CVD coating and a PVD coating.

The CVD coating is a chemical vapor deposition method of evaporating a hard material onto a surface of a base material by chemical reaction of gases at a high temperature of 900 to 1100 degrees C. Adhesion strength thereof to the base material is remarkably high, and a coating layer has abrasion resistance, heat resistance, oxidation resistance and chemical reaction resistance superior to cemented carbide. As a result, a tool applied with the CVD coating has a long service life and further is suitable for high-speed cutting. On the other hand, the PVD coating is a physical vapor deposition method of ionizing, reacting and evaporating an evaporation material at a relatively low temperature of 300 to 800 degrees C. by using electrical energy. Although adhesion between the film and the base material is inferior to that of the CVD method, a coating to an acute portion which is considered difficult in the CVD method is possible. The PVD coating is suitable for coating a blade point portion of the tip.

On the other hand, a coating performed at the end of the process in a conventional drill head manufacturing is the PVD coating which is a so-called low-temperature coating. That is, the conventional coating is provided after the cutting tip and the guide pad are silver brazed at a brazing temperature to the head main body and outer diameter portions of the brazed tip and guide pad are polished. Since the brazing temperature is 400 to 800 degrees C., a coating at a temperature higher than the brazing temperature moves or detaches the brazed portions, therefore, the PVD coating which is processed at a temperature lower than the brazing temperature is applied.

Accordingly, an object of the present invention is to provide a drill head manufacturing method in which the CVD coating is also applied in manufacturing of a drill head where conventionally only the PVD coating is applicable as described above, thereby utilizing features of the CVD method effectively, which renders a tip service life longer and enables a drill head more suitable for high-speed cutting to be manufactured. Another object of the present invention is to provide a drill head manufactured by this method.

### SUMMARY OF THE INVENTION

Means for solving the aforementioned problems will be described with reference symbols of an embodiment as shown in FIG. 1 which will be described later. A drill head manufacturing method according to a first aspect of the present invention comprises the steps of CVD coating a cutting tip 2 with a hard material, brazing the CVD coated cutting tip 2 at a brazing temperature to a predetermined portion at a distal end side of a head main body 1, polishing an outer diameter portion OD of the brazed tip 2 about a rotation axis G of the head main body 1, and then PVD coating the cutting tip 2 and the head main body 1 with a hard material at a temperature lower than the brazing temperature. During brazing, at least the CVD coated cutting tip 2 is located such that an outer diameter portion of the cutting tip 2 is positioned proximate an outer circumference of the drill head.

A second aspect is configured such that the hard materials used for respective CVD and PVD coatings are titanium carbide, titanium nitride, titanium carbonitride and/or alumina in the drill head manufacturing method as described in the first aspect.

A drill head according to a third aspect of the present invention comprises a cutting tip 2 CVD coated beforehand with a hard material, a head main body 1 having a predetermined portion at a distal end side thereof brazed with the CVD coated cutting tip 2, an outer diameter portion OD of the brazed tip 2 about a rotation axis G of the head main body 1, the outer diameter portion OD being polished, and the cutting tip 2 and the head main body 1 then PVD coated with a hard material.

A fourth aspect is configured such that the hard materials used for respective CVD and PVD coatings are titanium carbide, titanium nitride, titanium carbonitride and/or alumina in the drill head as described in the third aspect.

The drill head manufacturing method according to the first aspect of the present invention comprises the steps of CVD coating a cutting tip 2 under a high temperature, for example, about 1000 degrees C., brazing the CVD coated cutting tip 2 at a brazing temperature to a predetermined portion at a distal end side of a head main body 1 at, for example, about 600 degrees C. in advance, polishing an outer diameter portion OD of the brazed tip 2 about a rotation axis G of the head main body 1, and then PVD coating the cutting tip 2 and the head main body 1 at a temperature lower than the brazing temperature, for example, about 500 degrees C. Even if a CVD coating layer formed on a surface of the cutting tip 2 by the CVD coating is chipped off of a first blade point portion 2b at an outer circumferential side during polishing the outer diameter portion OD, the CVD coating layer is left as is on portions of the cutting insert in a region other than this outer diameter portion OD, in particular, on a second blade point portion 2a at a distal end side. Therefore, the second blade point portion 2a at the distal end side can exert characteristics of the CVD coating layer. That is, the characteristics of the CVD coating layer are that adhesion strength between the layer and a base material is remarkably high and the CVD coating layer has abrasion resistance and heat resistance superior to cemented carbide. Thus, the CVD coating layer formed on the second blade point portion 2a at the distal end side of the cutting tip 2 improves abrasion resistance and heat resistance of the second blade point portion 2a significantly, which leads to a longer service life of the cutting tip 2 and renders the cutting tip 2 suitable particularly for high-speed cutting.

Further, even if the CVD coating layer formed on the first blade point portion 2b at the outer circumferential side of the outer diameter portion OD of the cutting tip 2 about the rotation axis G of the head main body 1 is lost due to the polishing of the outer diameter portion OD, a PVD coating layer is formed on this first blade point portion 2b at the outer circumferential side by the PVD coating after the polishing. Thus, abrasion resistance and heat resistance of the first blade point portion 2b at the outer circumferential side are also ensured, thereby extending its service life, and accordingly the service life of the cutting tip 2 can be rendered longer. Since the PVD coating processing temperature is lower than the brazing temperature, the brazed portion cannot be melted and moved or detached by the PVD coating after the brazing. Further, a coating to an acute portion which is considered relatively difficult in the CVD coating becomes possible by the PVD coating. Blade point edges of the blade point portions 2a and 2b can be coated sufficiently.

As described in the second aspect, the hard materials used for respective CVD and PVD coatings are titanium carbide, titanium nitride, titanium carbonitride and/or alumina in the drill head manufacturing method as described in the first aspect.

The drill head according to the third aspect of the present invention is formed by the method as set forth in the first aspect. The cutting tip 2 having been CVD coated in advance is brazed at a brazing temperature to a predetermined portion at the distal end side of the head main body 1. An outer diameter portion OD of the brazed tip 2 about the rotation axis G of the head main body 1 is polished, and then the cutting tip 2 and the head main body 1 are PVD coated at a temperature lower than the brazing temperature. Thus, the cutting tip 2 has a longer service life and becomes suitable especially for high-speed cutting.

In such a drill head, the brazed-on cutting tip 2 may have a first portion provided with (a) either only a PVD coating or a PVD coating on top of a polished CVD coating, and (b) a second portion provided with a provided with a PVD coating on top of an unpolished CVD coating. The first portion may constitute at least a first section of the cutting tip's outer diameter portion OD and include the first blade point portion 2b at the outer circumferential side. The second portion may constitute the second blade point portion 2a at the distal end side. It is understood that there may be one or more CVD layers on both the first and second portions of the unfinished substrate, i.e., the cutting tip prior to the formation of the aforementioned polished or unpolished CVD coating followed by the PVD coating.

As described in the fourth aspect, the hard materials used for respective CVD and PVD coatings are titanium carbide, titanium nitride, titanium carbonitride and/or alumina in the drill head as described in the third aspect. In some embodiments, the hard material of the PVD coating may be the same as the hard material of the CVD coating, while in other embodiments the hard material of the PVD and the CVD coatings are different.

### BRIEF DESCRIPTION OF THE DRAWINGS

FIG. 1(a) is a front view showing a drill head manufactured by a method according to the present invention and FIG. 1(b) is a plan view thereof;

FIG. 2(a) is a front view showing another drill head manufactured by the method according to the present invention and FIG. 2(b) is a plan view thereof.

### DESCRIPTION OF REFERENCE CHARACTERS

A, B: Drill head

1: Head main body

2, 3, 4, 5: Cutting tip

6: Guide pad

OD: Outer diameter portion

G: Rotation axis of head main body

### DETAILED DESCRIPTION

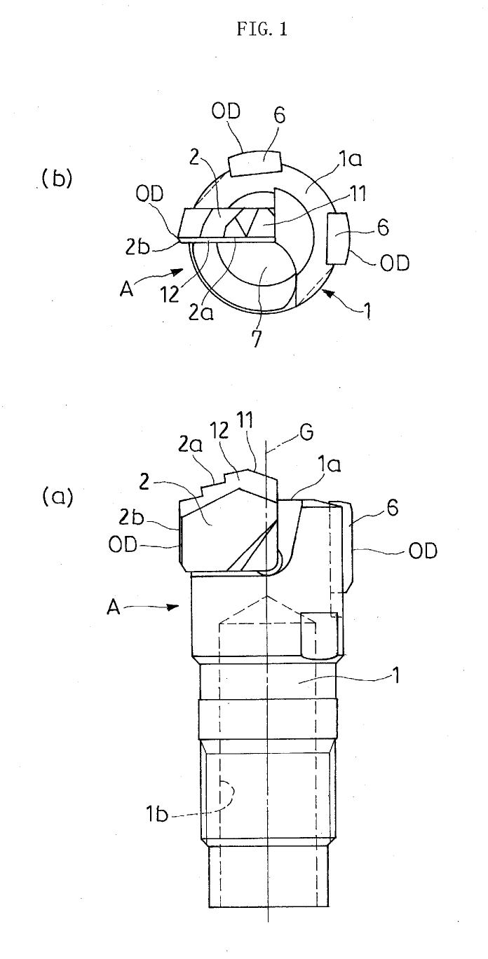

Preferred embodiments of the present invention will be described with reference to the drawings. FIG. 1(a) is a front view showing a drill head manufactured by a method according to the present invention, and FIG. 1(b) is a plan view thereof. The drill head A has a substantially cylindrical head main body 1. The head main body 1 has a distal end side surface 1a brazed with a piece of cutting tip 2 radially from a rotation axis G thereof. The cutting tip 2, upon brazing, has blade point portions 2a and 2b at a distal end side and an outer circumferential side, respectively. Moreover, guide pads 6 are brazed to predetermined portions on side surfaces of the head main body 1 in the same manner as the cutting tip 2. Reference numeral 7 denotes a chip discharge port communicated with a hollow portion 1b of the head main body 1 in FIG. 1.

Embodiments of a manufacturing method of the drill head A will now be described.

First, the cutting tip 2 is CVD coated with a hard material. The CVD coated cutting tip 2 is silver brazed at a brazing temperature onto a first predetermined portion at the distal end side of the head main body 1. The guide pads 6 are silver brazed, again at a brazing temperature, onto one or more second predetermined portions on the side surface of the head main body 1. The CVD coated cutting tip 2 and the guide pads 6 are positioned during brazing such that an outer diameter portion of the cutting tip 2 and an outer diameter portion of the guide pads 6 are positioned proximate an outer circumference of the drill head. Then, outer diameter portions OD of the brazed cutting tip 2 and guide pad 6 about the rotation axis G of the head main body 1 are polished, thereby adjusting an outer diameter of the drill head A including the cutting tip 2 and the guide pad 6. After that, the cutting tip 2, the guide pad 6 and the head main body 1 are all PVD coated with a hard material at a temperature lower than the brazing temperature. As a result, in the PVD coating step, portions of the head main body other than where the cutting tip and the guide pads are located, receive a PVD coating.

In this manufacturing method, cemented carbide is used in one embodiment of the substrate for the cutting tip 2. The cemented carbide substrate may first be coated with one or more layers to form an unfinished substrate, “unfinished substrate” in this context meaning that at least one or more CVD and/or PVD coating remains to be applied.

For the CVD coating of the tip 2, titanium carbide, titanium nitride, titanium carbonitride and/or alumina are used as the hard material. Then, a film of titanium carbide, titanium nitride, titanium carbonitride and/or alumina, that is, a CVD coating layer is formed on a surface of the cutting tip 2 in a single layer (or multiple layers) with a film thickness of, for example, about 6 to 8 μm by a chemical vapor deposition (CVD) method under a high temperature, for example, 1000 degrees C. This CVD coating layer has abrasion resistance, heat resistance, oxidation resistance and chemical reaction resistance superior to cemented carbide.

In this case, the single CVD coating layer comprises any one desired layer of titanium carbide, titanium nitride, titanium carbonitride or alumina, and the multiple CVD coating layers are composed of a plurality of layers among titanium carbide, titanium nitride, titanium carbonitride and alumina, and can include layers of all of these.

A brazing temperature of the cutting tip 2 and the guide pad 6 to the head main body 1 is about 600 degrees C., for example.

Polished amounts of the outer diameter portions OD of the cutting tip 2 and the guide pad 6 about the rotation axis G of the head main body 1 are in some cases smaller than the film thickness of the CVD coating layer, and in other cases larger than that. Accordingly, when the polished amounts are smaller than the film thickness, a portion of the CVD coating layer is left. When the polished amounts exceed the film thickness, the CVD coating layer on the first blade point portion 2b at the outer circumferential side of the cutting tip 2 is fully removed and is not left.

Further, titanium carbide, titanium nitride, titanium carbonitride and/or alumina are used as the hard material in the PVD coating performed after the polishing of the outer diameter portions OD. Thus, a film of titanium carbide, titanium nitride, titanium carbonitride and/or alumina, that is, a PVD coating layer is formed on surfaces of the polished cutting tip 2, guide pad 6 and head main body 1 in a single layer (or multiple layers) with a film thickness of, for example, about 3 to 5 μm by a physical vapor deposition (PVD) method at, for example, about 500 degrees C. lower than the aforementioned brazing temperature, about 600 degrees C., of the cutting tip 2 and guide pad 6. The PVD coating is able to coat an acute portion, which is considered difficult in the CVD method, and is suitable for a coating to the blade point portions of the tip. Therefore, coating layers are accurately formed on acute portions of the blade point portions 2a and 2b of the cutting tip 2 as well.

In this case, the single PVD coating layer is composed of any one desired layer of titanium carbide, titanium nitride, titanium carbonitride or alumina, and the multiple PVD coating layers are composed of any plural layers among titanium carbide, titanium nitride, titanium carbonitride and alumina or layers of all of them.

According to the foregoing manufacturing method of the drill head A, the cutting tip 2 having been CVD coated with a hard material under a high temperature, for example, about 1000 degrees C. is brazed to a predetermined portion at the distal end side of the head main body 1 at, for example, a brazing temperature of about 600 degrees C. The outer diameter portion OD of the brazed tip 2 about the rotation axis G of the head main body 1 is polished, and then, the cutting tip 2, the guide pad 6 and the head main body 1 are PVD coated with a hard material at a temperature lower than the brazing temperature, for example, about 500 degrees C. Therefore, even if the CVD coating layer having been formed on the surface of the cutting tip 2 by the CVD coating is chipped off of the first blade point portion 2b at the outer circumferential side by the polishing of the outer diameter portion OD, the CVD coating layer is left as is on a region other than this outer diameter portion OD, especially on the second blade point portion 2a at the distal end side. Thus, the second blade point portion 2a at the distal end side can exert characteristics of the CVD coating layer. That is, the characteristics of the CVD coating layer are that adhesion strength between the layer and a base material is remarkably high and the CVD coating layer has abrasion resistance and heat resistance superior to cemented carbide. Thus, the CVD coating layer having been formed on the second blade point portion 2a at the distal end side of the cutting tip 2 significantly improves abrasion resistance and heat resistance of a flank face 11 and a cutting face 12 in the second blade point portion 2a at the distal end side. This renders the service life of the cutting tip 2 longer and the cutting tip 2 suitable particularly for high-speed cutting.

Further, even if the CVD coating layer having been formed on the first blade point portion 2b at the outer circumferential side of the outer diameter portion OD of the cutting tip 2 about the rotation axis G of the head main body 1 is lost due to the polishing of the outer diameter portion OD, a PVD coating layer is formed on this first blade point portion 2b at the outer circumferential side by the PVD coating after the polishing. Thus, abrasion resistance and heat resistance of the first blade point portion 2b at the outer circumferential side is also secured, and the service life thereof is extended. Accordingly, the service life of the cutting tip 2 can be extended. In addition, since the PVD coating processing temperature is lower than the brazing temperature, the brazed portion cannot be melted and moved or detached by the PVD coating after the brazing. Further, coating an acute portion, which is considered relatively difficult by using CVD, becomes possible by the PVD coating, and thus, a blade point edge of the second blade point portion 2a at the distal end side and a blade point edge of the first blade point portion 2b at the outer circumferential side can be coated sufficiently.

When the polishing step removes only some of the CVD coating on the first blade point portion 2b, the cutting tip 2 in the final drill head may comprise a first portion provided with a PVD coating on top of a CVD coating having a first thickness, and a second portion provided with a PVD coating on top of a CVD coating having a second thickness, the second thickness being greater than the first thickness. The CVD coating on the first portion may be thinner since it has been polished, while the CVD coating on the second portion remains unpolished. The first portion may constitute at least a first section of the cutting tip's outer diameter portion OD and thus include the first blade point portion 2b at the outer circumferential side. The second portion may constitute the second blade point portion 2a at the distal end side. The PVD coating in the second portion is formed on top of the CVD coating which remained unpolished during the polishing of the cutting tip's outer diameter portion OD.

When the polishing step removes all of the CVD coating on the first blade point portion 2b, the first thickness can be considered to be zero. Thus, the brazed-on cutting tip 2 in the final drill head may comprise a first portion provided with only a PVD coating on an unfinished substrate (the pre-brazing CVD coating on the first portion having been fully removed by the polishing step), and a second portion provided with a PVD coating on top of the unpolished CVD coating which still has the aforementioned second thickness.

In either case, in some embodiments, the hard material of the PVD coating may be the same as the hard material of the CVD coating, while in other embodiments the hard material of the PVD and the CVD coatings are different. Also, in either case, there may be one or more CVD layers on both the first and second portions of the unfinished substrate, prior to the application of the aforementioned CVD and PVD layers.

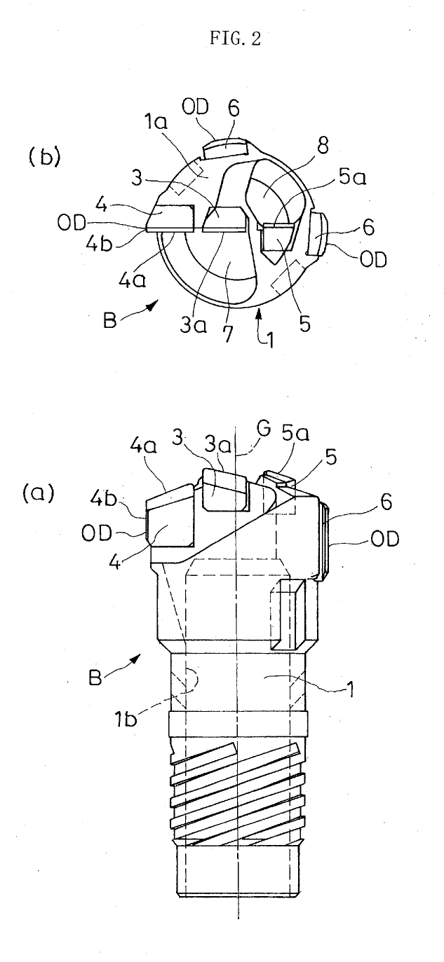

FIG. 2(a) is a front view showing another drill head manufactured by the method according to the present invention, and FIG. 2(b) is a plan view thereof. The drill head B has a substantially cylindrical head main body 1. The head main body 1 has a distal end side surface 1a formed with a large and a small chip discharge port 7 and 8 communicated with a hollow portion 1b and opposed to each other in a diameter direction. A central cutting tip 3 and a circumferential cutting tip 4 are brazed at a brazing temperature to an opening side edge of the large chip discharge port 7 along a radial direction of the head main body 1, and an intermediate cutting tip 5 is brazed to an opening side edge of the small chip discharge port 8 along the radial direction of the head main body 1, respectively. Further, guide pads 6 are brazed to predetermined portions on side surfaces of the head main body 1.

A manufacturing method of the drill head B will be briefly described. First, the central, circumferential and intermediate cutting tips 3 to 5 are CVD coated with a hard material. Then the CVD coated cutting tips 3 to 5 are silver brazed at a brazing temperature to predetermined portions at the distal end side of the head main body 1. Also, the guide pad 6 is silver brazed to a predetermined portion on a side surface of the head main body 1. Then, outer diameter portions OD of the silver brazed circumferential cutting tip 4 and guide pad 6 about the rotation axis G of the head main body 1 are polished to adjust an outer diameter of the drill head B including the circumferential cutting tip 4 and the guide pad 6. After that, the whole of the central, circumferential and intermediate cutting tips 3 to 5, guide pad 6, and the head main body 1 is PVD coated with a hard material at a temperature lower than the brazing temperature. In this case, the CVD coating temperature is about 1000 degrees C., the brazing temperature is about 600 degrees C. and the PVD coating temperature is about 500 degrees C., which are the same for the drill head A.

In the manufacturing method of the drill head B, cemented carbide is used for the cutting tips 3 to 5. For the CVD and PVD coatings of the tips 3 to 5, titanium carbide, titanium nitride, titanium carbonitride and/or alumina are used as the hard material in the same manner as the drill head A.

The foregoing manufacturing method of the drill head B comprises brazing the CVD coated three central, circumferential and intermediate cutting tips 3 to 5 to predetermined portions at the distal end side of the head main body 1, polishing outer diameter portions OD of the circumferential cutting tip 4 and guide pad 6 about the rotation axis G of the head main body 1, and then, PVD coating the cutting tips 3 to 5, the guide pad 6 and the head main body 1 at a temperature lower than the brazing temperature. CVD coating layers are formed on respective surfaces of three of the central, circumferential and intermediate cutting tips 3 to 5 by the CVD coating. Thus, the CVD coating layers of the central and intermediate cutting tips 3 and 5 are unpolished and left as they are. Even if the CVD coating layer on a first blade point portion 4b at the outer circumferential side of the circumferential cutting tip 4 is chipped off and removed due to the polishing of the outer diameter portion OD thereof, the CVD coating layer remains on a region other than the outer diameter portion OD, particularly on a second blade point portion 4a at the distal end side. Thus, characteristics of the CVD coating layer can be exerted, whereby abrasion resistance and heat resistance of the second blade point portion 4a at the distal end side and a flank face and a cutting face thereof are significantly improved, and accordingly, the service life of the circumferential cutting tip 4 is extended. The central and intermediate cutting tips 3 and 5, in particular, blade point portions 3a and 5a at the distal end side and flank faces and cutting faces thereof can sufficiently exert the characteristics of the CVD coating layer, respectively. The cutting tips 3 and 5 result in having longer service lives. Accordingly, the drill head B itself has a longer service life and becomes optimum for high-speed cutting.

Further, even when the CVD coating layer is removed from the first blade point portion 4b at the outer circumferential side of the outer diameter portion OD of the circumferential cutting tip 4 about the rotation axis G of the head main body 1, a PVD coating layer is formed on this first blade point portion 4b at the circumferential side by the PVD coating after the polishing. Consequently, the service life of the first blade point portion 4b at the outer circumferential side can be extended, which leads to a longer life of the circumferential cutting tip 4. Further, the guide pad 6 is also PVD coated and formed with a PVD coating layer, and thus, abrasion resistance and heat resistance of outer circumferential surfaces thereof are improved and the service life thereof can be extended.

What is claimed is:

1. A drill head manufacturing method comprising the steps of:
CVD coating a cutting tip with a first hard material;
brazing the CVD coated cutting tip at a brazing temperature, to a predetermined portion at a distal end side of a head main body such that an outer diameter portion of the cutting tip is positioned proximate an outer circumference of the drill head;
polishing the outer diameter portion of the brazed tip about a rotation axis of the head main body; and
PVD coating the cutting tip with a second hard material at a second temperature lower than the brazing temperature.

2. The drill head manufacturing method according to claim 1, wherein the first and second hard materials used for respective CVD and PVD coatings are one or more from the group consisting of titanium carbide, titanium nitride, titanium carbonitride and alumina.

3. The drill head manufacturing method according to claim 1, wherein the first hard material is the same as the second hard material.

4. The drill head manufacturing method according to claim 1, wherein the first hard material is different from the second hard material.

5. The drill head manufacturing method according to claim 1, wherein:
the polishing step removes at least a portion of the first hard material formed by the CVD coating step from a first blade point portion located at an outer circumferential side of the cutting tip.

6. The drill head manufacturing method according to claim 5, wherein:
the polishing step entirely removes the first hard material formed by the CVD coating step, from said first blade point portion.

7. The drill head manufacturing method according to claim 6, wherein:
the PVD coating step coats the second hard material onto said first blade point portion from which the first hard material was entirely removed.

8. The drill head manufacturing method according to claim 7, wherein:
the PVD coating step also coats at least one guide pad brazed onto the head main body, the at least one guide pad being positioned such that at least an outer diameter portion thereof is positioned proximate the outer circumference of the drill head.

9. The drill head manufacturing method according to claim 5, wherein:
the PVD coating step coats the second hard material onto said first blade point portion from which said at least a portion of the first hard material was removed.

10. The drill head manufacturing method according to claim 5, wherein:
the PVD coating step also coats at least one guide pad brazed onto the head main body, the at least one guide pad being positioned such that at least an outer diameter portion thereof is positioned proximate the outer circumference of the drill head.

11. The drill head manufacturing method according to claim 1, wherein:
the polishing step polishes outer diameter portions OD of the brazed cutting tip and also of at least one guide pad brazed onto the head main body, thereby adjusting an outer diameter of the drill head.

12. The drill head manufacturing method according to claim 11, wherein:
the PVD coating step also coats said at least one guide pad.

13. The drill head manufacturing method according to claim 1, wherein:
the PVD coating step coats portions of the head main body other than where the cutting tip and the guide pads are located.

14. A drill head comprising:
a cutting tip CVD coated with a hard material;
a head main body having a predetermined portion at a distal end side thereof brazed with the CVD coated cutting tip;
an outer diameter portion of the brazed tip about a rotation axis of the head main body, the outer diameter portion being polished; and
the cutting tip and the head main body then PVD coated with a hard material at a temperature lower than a brazing temperature.

15. The drill head according to claim 14, wherein the hard materials used for respective CVD and PVD coatings are titanium carbide, titanium nitride, titanium carbonitride and/or alumina.

16. A drill head having an outer circumference, and comprising:
a head main body having a distal end side;
a cutting tip brazed onto the distal end side of the head main body, such that an outer diameter portion of the cutting tip is positioned proximate the outer circumference of the drill head;
one or more guide pads brazed onto the distal end side of the head main body, such that an outer diameter portion of each guide pad is positioned proximate the outer circumference of the drill head, the outer diameter portion of each guide pad being polished; wherein:
a first portion of the cutting tip is provided with a PVD coating on top of a CVD coating having a first thickness;
a second portion of the cutting tip is provided with a PVD coating on top of a CVD coating having a second thickness, the second thickness being larger than the first thickness;
the first portion of the cutting tip comprises a first blade point portion located proximate the outer circumference of the drill head;
the second portion of the cutting tip comprises a second blade point portion located at the distal end side;
the CVD coatings on the first and second portions comprise a first hard material, and
the PVD coatings on the first and second portions comprise a second hard material.

17. The drill head according to claim 16, wherein:
the first and second hard materials used for the respective CVD and PVD coatings are one or more from the group consisting of titanium carbide, titanium nitride, titanium carbonitride and alumina.

18. The drill head according to claim 16, wherein the first hard material is the same as the second hard material.

19. The drill head according to claim 14, wherein:
the one or more guide pads have a PVD coating; and
portions of the head main body, other than where the cutting tip and the guide pads are located, have a PVD coating.

20. The drill head according to claim 14, wherein:
the first thickness is zero; and
the PVD coating coats an unfinished substrate.

21. A drill head having an outer circumference, and comprising:
a head main body having a distal end side;
a cutting tip brazed onto the distal end side of the head main body, such that an outer diameter portion of the cutting tip is positioned proximate the outer circumference of the drill head;
one or more guide pads brazed onto the distal end side of the head main body, such that an outer diameter portion of each guide pad is positioned proximate the outer circumference of the drill head, the outer diameter portion of each guide pad being polished; wherein:
a first portion of the cutting tip is provided with a PVD coating;
a second portion of the cutting tip is provided with a PVD coating on top of a CVD coating;
the first portion of the cutting tip comprises a first blade point portion located proximate the outer circumference of the drill head;
the second portion of the cutting tip comprises a second blade point portion located at the distal end side;
the CVD coating on the second portion comprises a first hard material, and
the PVD coatings on the first and second portions comprise a second hard material.
